(19) United States
(12) Patent Application Publication
(10) Pub. No.: US 2026/0254295 A1
(43) Pub. Date: Aug. 27, 2026

(54) TRANSVERSAL FLUX MACHINE

(71) Applicants: Danfoss Power Electronics A/S, Grästen (DK); Electric Torque Machine, Flagstaff, AZ (US)

(72) Inventors: Niels Hedegaard GADE, Sønderborg (DK); Peter Scavenius Andersen, Sønderborg (DK); Tyler Williams, Flagstaff, AZ (US); Scott Reynolds, Flagstaff, AZ (US)

(21) Appl. No.: 19/544,057

(22) Filed: Feb. 19, 2026

(30) Foreign Application Priority Data
Feb. 24, 2025 (DE) 102025106886.0

(51) Int. Cl. H02K 1/18; H02K 15/40

(52) U.S. Cl. CPC H02K 1/185; H02K 15/40; H02K 2201/12; H02K 2213/03; H02K 2213/12

(57) ABSTRACT

The present disclosure pertains to a transversal flux machine (TFM) including a number of Stator phase modules each including a coil and an armature, and a rotor with magnetic pole pairs. At least two stator phase modules are stacked axially with respect to each other and displaced in a circumferential direction with respect to each other. The stator phase modules are selected from a range of at least two different types of stator phase modules, wherein the different types of stator phase modules have different electrical characteristics, and wherein preferably all types of stator phase modules are provided for being mechanically connectable to each other independently of their respective type. The present disclosure also pertains to an integrated electric motor application including a motor drive and a transversal flux machine.

### CROSS-REFERENCE TO RELATED APPLICATIONS

This application claims foreign priority benefits under 35 U.S.C. § 119 to German Patent Application No. 102025106886.0 filed on Feb. 24, 2025, the content of which is hereby incorporated by reference in its entirety.

### TECHNICAL FIELD

The present invention pertains to a transversal flux machine (TFM) comprising a number of Stator phase modules each comprising a coil and an armature, and a rotor with magnetic pole pairs. At least two stator phase modules are stacked axially with respect to each other and displaced in a circumferential direction with respect to each other. The stator phase modules are selected from a range of at least two different types of stator phase modules, wherein the different types of stator phase modules have different electrical characteristics, and wherein preferably each type of stator phase module is provided for being mechanically connectable to other stator phase modules of the same type. The present invention also pertains to an integrated electric motor application comprising a motor drive and a transversal flux machine.

### BACKGROUND

In radial flux machines, power scaling is easily achieved by adjusting the axial length of the motor i.e. its stack height. However, for transversal flux machines, this is not immediately possible as the stator geometry is a more complex 3D structure that cannot directly be varied mechanically.

### SUMMARY

The aim of the present invention is to overcome this problem and to provide an improved transversal flux machine, which can be easily scaled to various power ratings and speeds.

This aim is achieved by a transversal flux machine according to claim 1, an integrated electric motor application according to claim 16 and a method for manufacturing a transversal flux machine according to claim 17. Advantageous embodiments of the invention are subject to the dependent claims.

According to claim 1, a transversal flux machine is provided, which comprises a number of stator phase modules, each stator phase module comprising a coil and an armature. The transversal flux machine further comprises a rotor with magnetic pole pairs. According to the invention, at least two stator phase modules are stacked axially with respect to each other. These stator phase modules are displaced in a circumferential direction with respect to each other. The stator phase modules are selected from a range of at least two different types of stator phase modules, wherein the different types of stator phase modules have different electrical characteristics, and wherein preferably each type of stator phase module is provided for being mechanically connectable to other stator phase modules of the same type.

The stator phase modules are placed coaxially with respect to each other while having a circumferential displacement with respect to each other. The number and types of stator phase modules may be selected to match a certain desired power range of the transversal flux machine, such that a wide power range may be covered with the same construction principle of the transversal flux machine and with common components.

The present invention makes it possible to scale the transversal flux machine to a desired power rating by selecting a suitable number and suitable types of phases in the machine. Additionally, the selected stator phase modules can be connected electrically in any suitable combination of single phase, series and/or parallel connections, such that numerous desired transversal flux machine characteristics may be obtained using only at least two different types of stator phase modules. Since in a transversal flux machine the individual phases are stacked axially, this effectively corresponds to increasing the motor axial length in discrete steps.

In a preferred embodiment, exactly two stator phase modules are provided and displaced by 2π/(4×Zpp), Zpp being the number of magnetic pole pairs and the given angle referring to a circumferential displacement between any two neighbouring stator phase modules in the present invention.

In another preferred embodiment, exactly four stator phase modules are provided in two pairs, with stator phase modules in a pair being displaced by a 0°±10° angle between them and with the pairs being displaced by 2π/(4×Zpp), Zpp being the number of magnetic pole pairs. The number of magnetic pole pairs Zpp may refer to the number of magnetic pole pairs in the rotor of the TFM. Shifting the two modules in a pair slightly by an angle smaller than say 10° can serve for mitigating cogging torque.

In another preferred embodiment, exactly four stator phase modules are provided in two pairs, with stator phase modules in a pair being displaced by a 180°±10° angle between them and with the pairs being displaced by 2π/(4×Zpp), Zpp being the number of magnetic pole pairs, wherein the polarity of one of the coils in each pair is reversed.

In another preferred embodiment, exactly two stator phase modules are provided and displaced by 2π/(3×Zpp), Zpp being the number of magnetic pole pairs.

In another preferred embodiment, exactly six stator phase modules are provided in pairs of two, with stator phase modules in a pair being displaced by a 0°±10° angle between them and with the pairs being displaced by 2π/(3×Zpp), Zpp being the number of magnetic pole pairs.

In another preferred embodiment, exactly six stator phase modules are provided in three pairs, with stator phase modules in pairs of two, with stator phase modules in a pair being displaced by a 180°±10 ° angle between them and with the pairs being displaced by 2π/(3×Zpp), Zpp being the number of magnetic pole pairs, wherein the polarity of one of the coils in each pair is reversed.

In another preferred embodiment, the circumferential displacement between the stator phase modules is defined by mechanical features of the armature of each stator phase modules and/or of at least one separation plate, wherein the separation plate is provided between two stator phase modules. The mechanical features and/or the separation plate may be shaped such that desired circumferential displacement between the stator phase modules is achieved.

In another preferred embodiment, each stator phase module and/or separation plate comprises circumferential displacement grooves, holes, and/or protrusions and/or the separation plate is a plastic plate or ring.

In another preferred embodiment, four or six stator phase modules are provided and the stator coils of the stator phase modules are coupled to each other in series or in parallel connected pairs.

The stator phase module may consist of an armature i.e. an iron part and a coil with windings. The coils of the stator phase modules of one machine may have the same physical outer dimensions, but may vary with regard to other characteristic. For example, they may have fewer turns with a thicker wire, thus keeping the volume constant. Fewer turns in a coil can be needed for either higher speed or lower supply voltage applications.

In another preferred embodiment, an electrical interface of the machine comprises three terminals regardless of the number of stator phase modules. This implies that 3 or 6 stator phase modules machines will be coupled in Star or Delta configuration, and 2 or 4 phase module machines will provide access to the common point. In each case the machine is intended for a 3-phase inverter.

In another preferred embodiment, four stator phase modules are arranged in a non-repetitive current phase order to reduce phase asymmetry, preferably in the order 1-2-2-1, the numbers denoting the two different current phases provided at the corresponding stator phase modules. The non-repetitive arrangement of the stator phase modules helps mitigating motor imbalances.

In another preferred embodiment, six stator phase modules are arranged in a non-repetitive current phase order to reduce phase asymmetry, preferably in the order 1-2-3-2-1-3,the numbers denoting the three different current phases provided at the corresponding stator phase modules. The non-repetitive arrangement of the stator phase modules helps mitigating motor imbalances.

In another preferred embodiment, the armature comprises a plurality of coil variants for accommodating a wide range of motor parameters.

In a particularly preferred embodiment, at least two types of coil variants in either 2 or 3 phases are used in either series or parallel for allowing the configuration of up to 18 different power ratings.

The invention is also directed at an integrated electric motor application comprising a motor drive and a transversal flux machine.

The invention is also directed at a method for manufacturing a transversal flux machine and comprises the steps of selecting at least two stator phase modules of the same type from a range of at least two different types of stator phase modules, and assembling the transversal flux machine using the selected stator phase modules.

In a preferred embodiment of the method, the stator phase modules comprise three distinct winding types to allow the configuration of up to 22 different types of TFM.

The manufacturing method may comprise any further steps required for providing the desired TFM, including providing the various possible electrical connections between the stator phase modules of the desired TFM. The manufacturing method with its use of two different types of stator phase modules and the various ways in which the stator phase modules can be connected to each other makes it possible to provide 18 different types of transversal flux machines. In case of three different types of stator phase modules 22 different types of transversal flux machine can be provided.

### BRIEF DESCRIPTION OF THE DRAWINGS

Further details and advantages are described with reference to the embodiments shown in the figures, wherein the features of the various embodiments may be combined in any physically possible manner within the scope of the invention. The figures show:

FIG. 1: details of stator phase module of the transversal flux machine;

FIG. 2: schematic view of transversal flux machine with 3 and 2 stator phase modules;

FIG. 3: schematic examples of coiling in stator phase modules;

FIGS. 4a-4d: overview of possible TFM configurations; and

FIG. 5: table of possible combinations of various numbers of stator phase modules.

### DETAILED DESCRIPTION

The present invention describes a new concept for motor power scaling in which individual motor phases are considered as building blocks. This can is done for a particular type of the motor, the transversal flux machine.

In general, the transversal flux machine (TFM) consists of a number of individual phases or stator phase modules, which are stacked axially. Contrary to radial flux machines, the phase coils do not share the same radial cross section or the same rotor magnetic flux.

The present invention focuses on using the individual stator phase modules as building blocks for a wider motor program, covering different torque, power and voltage ranges.

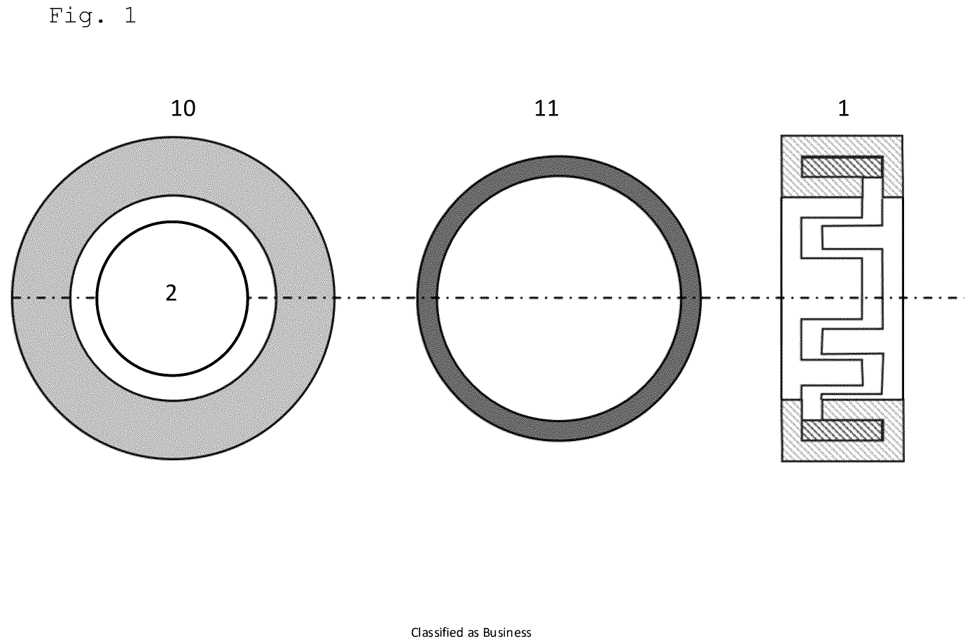

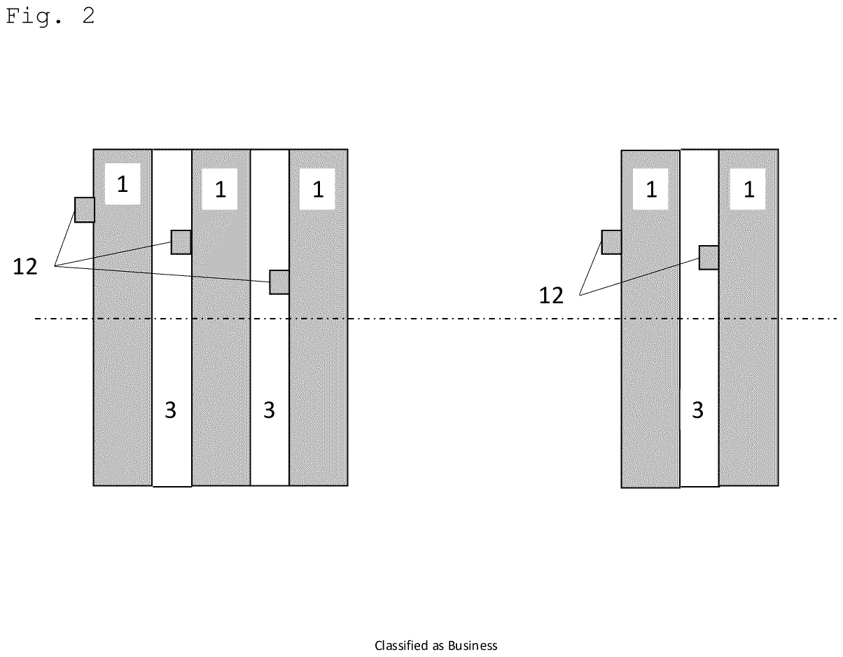

As seen in FIG. 1, a stator phase module 1 comprises an armature 10 and a coil 11, wherein the armature 10 may be made of steel and the coil 11 may be a copper coil. The present invention's transversal flux machine may in principle comprise any desired number of stator phase modules 1, each stator phase module 1 comprising a coil 11 and an armature 10. The transversal flux machine further comprises a rotor 2 with magnetic pole pairs. According to the invention, at least two stator phase modules 1 are stacked axially with respect to each other. These stator phase modules 1 are displaced in a circumferential direction with respect to each other as will be shown in FIG. 2.

For a given rotor design, the stator phase module 1 design can be optimized so that in combination with other identical or similar stator phase modules 1 the desired operating characteristics of a motor can be achieved. In particular, two or more different types of stator phase modules 1 can be defined, wherein each type has different electrical characteristics than the other types. This means that the individual stator phase module 1 with its corresponding rotor 2 design may be optimized for a given torque at a given speed. The rotor 2 design is not shown in FIG. 1 in detail. The rotor 2 may be provided radially within the toroidal stator phase module 1 as indicated on the left side of FIG. 1.

Considering the possibility of axially stacking 2,3,4, 6 or more stator phase modules 1 and targeting a nominal torque of e.g. 0,75 to 1,25 times the optimal torque Tₒₚₜ for one stator phase module 1, mechanically identical stator phase modules 1 with identical electrical characteristics can be used in motors covering a power range of a factor of 5. This corresponds to a range between 0.75×2×Tₒₚₜ=1,5 Tₒₚₜ and 1.25×6×Tₒₚₜ=7,5 Tₒₚₜ. Furthermore, keeping the physical dimensions and copper content of the coil 11 but varying the number of turns allows for a different voltage or speed range in the given motor.

Thus, the same armature 10 part and two different winding configurations of the coil 11 can be used for providing the two different types of stator phase modules 1 and allow for a power range of factor 5, at a speed range of factor 2 and a voltage range of factor 2. If a wider variety of motors is required, more than two, e.g. three different types of stator phase modules 1 may be used for providing the presently described modular transversal flux machine concept.

Motors comprising 2, 4 and optionally 6 stator phase modules can be run in a two-phase configuration. With more than one modules per phase, the phase modules in a phase may be coupled in parallel or series with coupled phase modules having 0 or 180° angular displacement±10°.

This requires that the stator phase modules may be displaced angularly by 2 π/(4 x Zpp), Zpp being the number of pole pairs.

Motors consisting of 3 and optionally 6 stator phase modules 1 may be arranged such that the stator phase modules 1 are displaced angularly by 2 π/(3 x Zpp).

FIG. 2 shows a schematic view of transversal flux machines with 3 and 2 stator phase modules. Since the individual stator phase modules 1 are stacked axially, the angular displacement can be controlled by either mechanical features 12 in the armature 10 and/or a plastic separation plate 3 with e.g. pre-stamped angular displacement grooves or holes.

In the left side of FIG. 2, a configuration with three stator phase modules 1 is shown while on its right side a configuration with two stator phase modules 1 is shown. The white inter-phase part i.e. the separation plate 3 may be a plastic plate or ring. The circumferential displacement between the stator phase modules 1 is defined by mechanical features 12 of the armature 10 of each stator phase module 1 and/or of at least one separation plate 3 such as notches 12 or protrusions, wherein the separation plate 3 is provided between two stator phase modules 1.

An inherent feature of TFM is asymmetric stray or mutual inductive coupling of phases contrary to radial flux machines. This can give rise to motor impedance asymmetry which is in general not desired.

For motors consisting of 4 or 6 phase modules, i.e. with two phase modules per phase, the axial order of phase modules can be selected so as to minimize asymmetric couplings.

FIG. 2 provides an illustration of the variants of motors that can be generated with one TFM phase as a building block-the building block having at least two different winding properties and preferably identical mechanical properties, especially outer dimensions.

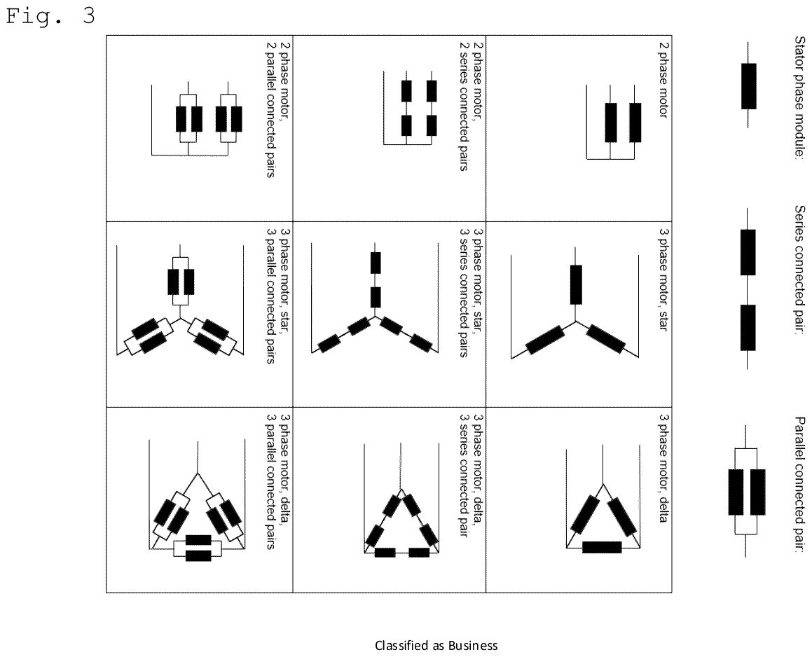

FIG. 3 shows different examples of coiling in stator phase modules 1. Generally, stator phase modules 1 can be provided in series or parallel connected pairs. Depending on the number of stator phase modules 1, a combination of series and/or parallel connected modules 1 may be used.

In embodiments with two stator phase modules 1, one port of each stator phase module 1 may be connected to each other to form a common point.

In embodiments with three stator phase modules 1, the stator phase modules 1 may be connected to each other in a star or delta configuration.

In embodiments with 4 stator phase modules 1, one port of two series connected modules 1 may be connected to one port of two other series connected modules 1 to form a common point. Alternatively, one port of two parallel connected modules 1 may be connected to one port of two other parallel connected modules 1 to form a common point.

In embodiments with 6 stator phase modules 1, each of three pairs of series connected modules 1 may be connected to each other in a star or delta configuration. Alternatively, each of three pairs of parallel connected modules 1 may be connected to each other in a star or delta configuration.

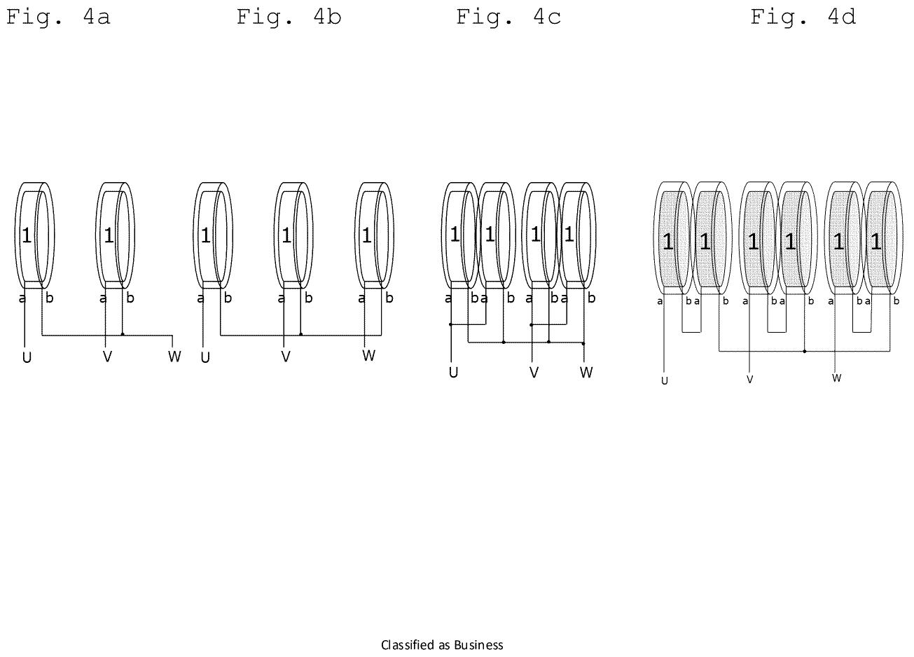

FIG. 4a-4d provide an overview of the principle according to which various TFMs can be configured according to the present invention and using only two or more different types of stator phase modules 1. In the following figures, the stator phase modules 1 of the TFMs are shown connected to phases u, v, w and/or to each other via ports a and b, thus creating various combinations of single-phase connections, parallel and/or series connections.

Generally, in TFMs, complex steel armatures are wrapped around simple copper coils. The present invention makes it possible to reduce manufacturing complexity by providing modular TFM components, especially stator phase modules 1. This means that identical or similar armatures can be used in combination with different types of copper coils to provide different types of stator phase modules 1.

From a single mechanical stator phase module 1 design, different two and three phase motors can be built, which cover a broad power range simply by operating the same or different types of modules 1 in two or three phase configurations. For example, either one, two or more modules 1 in series or parallel connection are provided per phase u, v, w.

FIG. 4a shows a simple embodiment of the TFM with two stator phase modules 1, with one phase module 1 being connected to phases u and w and the other phase module 1 connected to v and w. Other component of the TFM than the stator phase modules 1 will not be shown in the following figures for the sake of clarity. In this and in any other embodiment, the stator phase modules 1 may be of the same or of different types, i.e. having different electrical characteristics.

FIG. 4b shows another embodiment of the TFM with three stator phase modules 1, in which each stator phase module 1 is connected to a different phase u, v and w via one of their respective ports a. The other ports b connect the three stator phase modules 1 to each other rather than to any of the phases u, v or w.

FIG. 4c shows two pairs of stator phase modules 1. The first pair is connected to the same phase u via their ports a and to phase w via their ports b. The modules 1 of the first pair are connected in parallel to each other. The second pair is connected to phase v via their ports a and also to phase w via their ports b. The modules 1 of the second pair are therefore also connected in parallel to each other.

FIG. 4d shows three pairs of stator phase modules 1. The first parallel connected pair is connected to phase u. The second parallel connected pair is connected to phase v. The third parallel connected pair is connected to phase w.

FIGS. 4a to 4d show examples of how various numbers and types of stator phase modules 1 can be connected to each other.

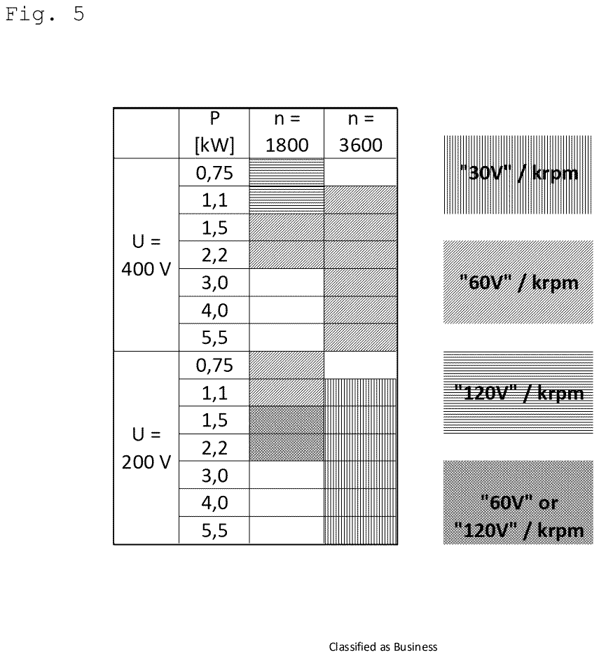

Generally, when using three different types of stator phase modules 1, FIG. 5 shows possible combinations of between two and six stator phase modules 1 resulting in different TFM characteristics. The different examples of stator phase module 1 types are characterized as 30 V/krpm, 60 V/krpm and 120 V/krpm, respectively, and indicated by different types of lines. The use of at least two different types of stator phase modules 1 and the various ways in which they can be connected to each other to form a single transversal flux machine makes it possible to provide 18 different types of transversal flux machines.

While the present disclosure has been illustrated and described and with respect to a particular embodiment thereof, it should be appreciated by those of ordinary skill in the art that various modifications to this disclosure may be made without departing from the spirit and scope of the present disclosure.

What is claimed is:

1. A transversal flux machine comprising:
a number of stator phase modules each comprising a coil and an armature, and
a rotor with magnetic pole pairs,
wherein at least two stator phase modules are stacked axially with respect to each other, and
wherein the stator phase modules are displaced in a circumferential direction with respect to each other, wherein the stator phase modules are selected from a range of at least two different types of stator phase modules,
wherein the different types of stator phase modules have different electrical characteristics, and
that preferably each type of stator phase module is provided for being mechanically connectable to other stator phase modules of the same type.

2. The transversal flux machine according to claim 1, wherein exactly two stator phase modules are provided and displaced by 2π/(4×Zpp), Zpp being the number of magnetic pole pairs.

3. The transversal flux machine according to claim 1, wherein exactly four stator phase modules are provided in two pairs, with stator phase modules in a pair being displaced by a 0°±10° angle between them and with the pairs being displaced by 2π/(4×Zpp), Zpp being the number of magnetic pole pairs.

4. The transversal flux machine according to claim 1, wherein exactly four stator phase modules are provided in two pairs, with stator phase modules in a pair being displaced by a 180°±10° angle between them and with the pairs being displaced by 2π/(4×Zpp), Zpp being the number of magnetic pole pairs, wherein the polarity of one of the coils in each pair is reversed.

5. The transversal flux machine according to claim 1, wherein exactly three stator phase modules are provided and displaced by 2π/(3×Zpp), Zpp being the number of magnetic pole pairs.

6. The transversal flux machine according to claim 1, wherein exactly six stator phase modules are provided in pairs of two, with stator phase modules in a pair being displaced by a 0°±10° angle between them and with the pairs being displaced by 2π/(3×Zpp), Zpp being the number of magnetic pole pairs.

7. The transversal flux machine according to claim 1, wherein exactly six stator phase modules are provided in pairs of two, with stator phase modules in a pair being displaced by a 180°±10° angle between them and with the pairs being displaced by 2π/(3×Zpp), Zpp being the number of magnetic pole pairs wherein the polarity of one of the coils in each pair is reversed.

8. The transversal flux machine according to claim 1, wherein the circumferential displacement between the stator phase modules is defined by mechanical features of the armature of each stator phase module and/or of at least one separation plate, wherein the separation plate is provided between two stator phase modules.

9. The transversal flux machine according to claim 8, wherein each stator phase module and/or separation plate comprises circumferential displacement grooves, holes, and/or protrusions and/or that the separation plate is a plastic plate or ring.

10. The transversal flux machine according to claim 3, wherein four or six stator phase modules are provided and the stator coils of the stator phase modules are coupled to each other in series or in parallel connected pairs.

11. The transversal flux machine according to claim 1, wherein an electrical interface of the machine comprises three terminals regardless of the number of stator phase modules.

12. The transversal flux machine according to claim 3 and comprising four stator phase modules, wherein the stator phase modules are arranged in a non-repetitive current phase order to reduce phase asymmetry, preferably in the order 1-2-1-2, the numbers denoting the two different current phases provided at the corresponding stator phase modules.

13. The transversal flux machine according to claim 6 and comprising six stator phase modules, wherein the stator phase modules are arranged in a non-repetitive current phase order to reduce phase asymmetry, preferably in the order 1-2-3-2-1-3, the numbers denoting the three different current phases provided at the corresponding stator phase modules.

14. The transversal flux machine according to claim 1, wherein the stator phase modules comprising a plurality of coil variants for accommodating a wide range of motor parameters.

15. The transversal flux machine according to claim 14, wherein at least two types of coil variants in either 2 or 3 phases are used in either series or parallel for allowing the configuration of up to 18 different power ratings.

16. An integrated electric motor application comprising a motor drive and a transversal flux machine according to claim 1.

17. A method for manufacturing a transversal flux machine according to claim 1, wherein it comprises
1. selecting at least two stator phase modules of the same type from a range of at least two different types of stator phase modules, and
2. assembling the transversal flux machine using the selected stator phase modules.

18. The method according to claim 17, wherein the stator phase modules comprise three distinct winding types to allow the configuration of up to 20 different types of TFM.
